(19) United States
(12) Patent Application Publication
(10) Pub. No.: US 2026/0120121 A1
(43) Pub. Date: Apr. 30, 2026

(54) ENTERPRISE GENERATIVE AI ASSESSMENT FRAMEWORK

(71) Applicant: C3.ai, Inc., Redwood City, CA (US)

(72) Inventors: Qiwei Li, Fremont, CA (US); Youssef Aitousarrah, Redwood City, CA (US); Romain Juban, San Francisco, CA (US); Paritosh Pramod Ambekar, Redwood City, CA (US); Pranav Sivadas Menon, Redwood City, CA (US); Armaan Rashid Butt, San Francisco, CA (US); Rohit Rajendra Deshpande, Placentia, CA (US)

(21) Appl. No.: 19/375,122

(22) Filed: Oct. 30, 2025

Related U.S. Application Data
(60) Provisional application No. 63/714,105, filed on Oct. 30, 2024.

(51) Int. Cl. G06Q 30/018; G06N 20/00

(52) U.S. Cl. CPC G06Q 30/018; G06N 20/00

(57) ABSTRACT

Examples include a method of identifying background information for a target product; identifying one or more potential comparison products based on the background information using a vector store which stores data using searchable embedding values, wherein a specification is associated with each of the one or more potential comparison products; and generating an assessment of the target product using a multimodal model, wherein the multimodal model determines similarities between the target product and one or more potential comparison products and passages from the specifications associated with each of the one or more potential comparison products based on the similarities.

### BACKGROUND

Assessment documentation creation is an integral part of product and product development lifecycles and is traditionally performed manually by technically sophisticated users reviewing different types of assessment documentation who then prepare the assessment (e.g., a hazard report in medical device company). In one example, a hazard report may indicate a hazard (e.g., medical laser malfunction), a harm (e.g., bodily injury, injury to hand or eye), a hazardous situation (e.g., laser misfires), and a severity (e.g., low, medium, high).

### BRIEF DESCRIPTION OF DRAWINGS

Various examples in accordance with the present disclosure will be described with reference to the drawings, in which:

FIG. 1 depicts a diagram of an example of an enterprise generative artificial intelligence hazard analysis system according to some embodiments.

FIG. 2 depicts a flowchart of an example of a method of enterprise generative artificial intelligence assessment framework generation according to some embodiments.

FIG. 3 depicts a flowchart of an example of a method of enterprise generative artificial intelligence assessment framework generation according to some embodiments.

FIG. 4 depicts a diagram of an example network system for enterprise generative artificial intelligence assessment framework generation according to some embodiments.

FIG. 5 depicts a diagram of an example of a computing device.

### DETAILED DESCRIPTION

Producing such documents requires technically proficient users, large amounts of time, and many revisions due to human error and other inefficiencies. Additionally, the experience and expertise of the document authors varies, and this creates intra-writer variability in the quality of the output. Moreover, such manually produced documents have a relatively low trust factor since there is no way to know how the report was generated by looking at the report. These issues can significantly impact product and device development times, increase the amount of time required to update products and devices, increase risk of injury caused by the products, and a myriad of other problems.

A novel generative artificial intelligence assessment framework generation is disclosed herein which is directed to enterprise environments and the development of various products and devices (e.g., life sciences products). This disclosure introduces an enterprise generative artificial intelligence assessment framework generation designed specifically for enterprise environments to create complex documentation essential to the development of various products and devices, such as life sciences products. An example implementation automates the creation of assessment, which is traditionally done manually by technically sophisticated users.

Traditional generative artificial intelligence models and methodologies suffer from a variety of drawbacks, such as hallucination or use words that have similar but slightly different meaning, which may mean completely different things for different disease contexts or different government regulations in different geographies. This is particularly problematic in the life science space, since there is a very low fault tolerance threshold as errors may result in significant bodily injury and/or create different regulatory and compliance risks to the product launch and during the product lifecycle. Conventional approaches suffer from inefficiency and variability in creating an assessment for product and product development lifecycles, especially in enterprise environments like life sciences. Traditionally, this assessment is manually prepared by technically sophisticated users, which is time-consuming, prone to human error, and varies in quality due to differences in the authors' expertise, access to information, or ability to rapidly update. This traditional process can significantly impact product development times, increase the risk of injury caused by products, and create compliance issues.

As described herein, new innovative solutions automate the creation of these complex specialized documents using generative AI methodologies and models, thereby reducing the time and effort required, minimizing human error, and ensuring consistency and accuracy. Additionally, example aspects described herein address issues like hallucination and the use of imprecise words by implementing novel techniques such as using internal approved dictionaries and deploying the system within an enterprise environment to securely utilize sensitive data.

A novel technical solution uses generative AI methodologies and models to create documents efficiently and accurately with minimal user input. It processes simple and complex documents to extract specifications, reviews prior assessment, and generates new documents by comparing similarities and differences between old and new products. An example aspect produces explainability and traceability data that includes, for example, rationales used to determine the assessment, as well as, source identification, citations, and passages used in generation of the document.

In an example embodiment, a method involves identifying background information pertinent to a target product. This background information is then utilized to identify one or more potential comparison products by leveraging a vector store that organizes data using searchable embedding values. Each potential comparison product is associated with a detailed specification. Subsequently, an assessment of the target product is generated using a multimodal model. This model evaluates similarities between the target product and the identified comparison products, as well as relevant passages from their associated specifications, based on the determined similarities. This approach ensures a comprehensive and nuanced comparison, facilitating informed decision-making regarding the target product.

The enterprise generative artificial intelligence assessment framework generation implements several novel techniques to address hallucination and select precise words and phrases, and make it a practical solution in the life science space. For example, the system may include the attribution features discussed above. In some embodiments, the system may refer to internal approved dictionaries or encyclopedia to select words based on disease contexts and geographies. In some embodiments, the system may also be deployed entirely within an enterprise environment (e.g., an enterprise environment of a life science manufacturer). This can allow the system to utilize sensitive data to achieve maximum accuracy without having to expose that sensitive data outside the enterprise environment or be biased or corrupted by outside data in choosing its responses.

Example aspects enhance the assessment process for related products by utilizing existing documents of a predicate or ‘parent’ product and comparing them with those of an output or ‘child’ product. This comparison allows for the efficient retrieval of overlapping information from the mother document to be included in the new daughter document. Additionally, the invention generates new, non-overlapping information to be incorporated into the daughter document, ensuring comprehensive and up-to-date assessment documentation. This approach improves efficiency, reduces redundancy, and maintains consistency across related product documents.

To address issues such as hallucination and the use of imprecise words, the system implements several novel techniques, such as using internal approved dictionaries and deploying the system entirely within an enterprise environment to utilize sensitive data securely. This improves maximum accuracy and compliance with regulatory requirements.

Example implementations include various modules, such as a management module, product comprehension module, disclosure comprehension module, template comprehension module, disclosure generation module, format compliance module, content compliance module, artificial intelligence traceability module, model training module, model deployment module, enterprise deployment module, anti-hallucination and attribution module, interface module, alerting module, and communication module.

The enterprise generative artificial intelligence assessment framework generation enhances trust and verification by including rationales directly in the generated documents, indicating sources, citations, and passages used. The system mitigates hallucination by using internal approved dictionaries and deploying the system entirely within an enterprise environment, ensuring precise words and phrases relevant to specific contexts. Example implementations tailors documents and report generation schedules to meet specific compliance rules set by regulatory agencies like the FDA, speeding up development processes and ensuring adherence to regulatory standards. The modular design allows for the integration and normalization of disparate data from various sources, increasing processing speed, reducing performance delays, and allowing for individual module updates without affecting overall system performance. Additionally, the system can be rapidly deployed within an enterprise environment, allowing for the secure utilization of sensitive data without exposing it outside the enterprise, which is particularly beneficial for industries like life sciences. These benefits collectively make the system a practical and efficient solution for enterprise assessment documentation creation, especially in highly regulated industries.

The enterprise generative artificial intelligence assessment framework generation described herein may use generative artificial intelligence methodologies and models to automatically create documents efficiently (e.g., requiring minimal user input) and accurately. For example, an enterprise datastore may include various input documents for a variety of different products needed to generate the new document. When a new product is being developed or when an existing product is being updated, the system may automatically trigger generation of a new document (e.g., a hazard report for a pharmaceutical product). More specifically, the system may first process simple & complex documents in order to extract different specifications based on the specific use case. The system may then automatically review the different specifications and prior assessment documentations that are similar to the new or updated product (e.g., a predicate device for a medical device). Once the similar products have been identified, the system may compare the precise similarities and differences between the old and new products. Based on this analysis, the system may generate a prompt (e.g., multimodal prompt, large language model prompt) that may create the two parts of the new document using two unique methodologies—first, using the similarities, the prompts with multimodal models may retrieve parts of the old document and copy them over to the new document; second, using the differences, the prompts with multimodal models may generate new text, tables, and pictures and paste them in to the new document. The system may then use another prompt with a multimodal model to combine the two parts and generate the new final document.

The enterprise generative artificial intelligence assessment framework generation may also indicate directly in the generated new document the rationales that were used to generate the document. For example, the document generated by the enterprise generative artificial intelligence assessment framework generation may include additional fields (e.g., relative to old documentations of the same nature) indicating sources citations, passages of particular documents, and the like. Accordingly, the documents generated herein are not only created more efficiently and accurately than using the traditional approaches, but they also have a higher trust factor because the report can easily be verified and authenticated simply by reviewing the document itself.

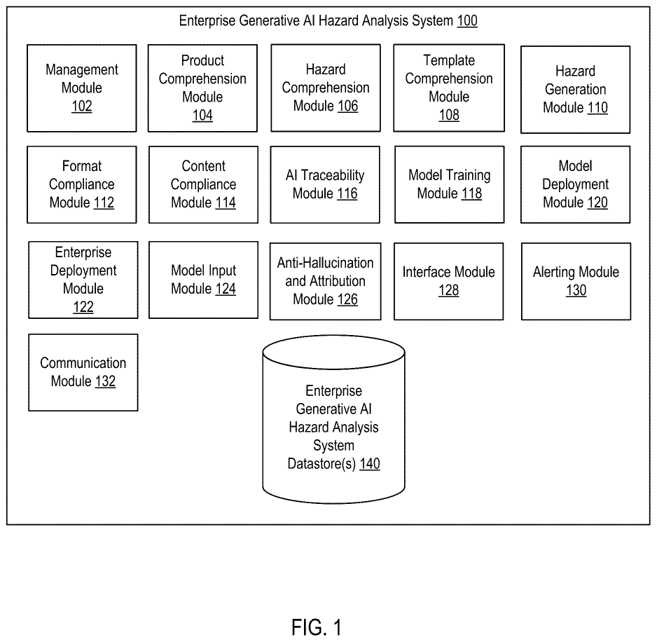

FIG. 1 depicts a diagram of an example of an enterprise generative artificial intelligence hazard analysis system 100 according to some embodiments. In the example of FIG. 1, the enterprise generative artificial intelligence hazard analysis system 100 includes a management module 102, a product comprehension module 104, a hazard comprehension module 106, a template comprehension module 108, a hazard generation module 110, a format compliance module 112, a content compliance module 114, an artificial intelligence traceability module 116, a model training module 118, a model deployment module 120, an enterprise deployment module 122, a model input module 124, an anti-hallucination and attribution module 126, an interface module 128, an alerting module 130, a communication module 132, and an enterprise generative artificial intelligence hazard analysis system datastore 140.

The management module 102 may function to manage (e.g., create, read, update, delete, or otherwise access) data associated with the enterprise generative artificial intelligence assessment framework generation 100. The management module 102 may manage some or all of the of the datastores described herein (e.g., enterprise generative artificial intelligence assessment framework generation datastore 140, data sources 406) and/or in one or more other local and/or remote datastores. It will be appreciated that datastores may be single or multiple datastores local to the enterprise generative artificial intelligence assessment framework generation 100 and/or single or multiple datastores remote from the enterprise generative artificial intelligence assessment framework generation 100. The datastores described herein may comprise one or more local and/or remote datastores. The management module 102 may perform operations manually (e.g., by a user interacting with a GUI generated by the interface module 128) and/or automatically (e.g., triggered by one or more of the modules 104-132). Like other modules described herein, some or all the functionality of the management module 102 may be included in and/or cooperate with one or more other modules, services, systems, and/or datastores.

In some embodiments, the management module 102 may manage, integrate, and/or normalize disparate data from disparate data sources. For example, the management module 102 may integrate various types of data from disparate data sources (e.g., enterprise data sources, external third-party data sources, etc.) having different data formats, and the like. The data may include product information (e.g., product specifications, user manuals), quality and regulatory information (e.g., hazard reports, historical data (e.g., historical hazard reports), real-time or live data (e.g., quality or R&D reports that are currently being generated and/or revised), etc. The management module 102 may use predefined integration rules to integrate and/or normalize some or all of the data described herein.

In some embodiments, the management module 102 may create and manage execution pipes for some or all of the modules 104-130. For example, the management module 102 may create a pipe wherein several of the modules 104-130 are executed serially and/or in parallel. This may provide modularity features that increase processing speed, reduce performance delays, and allow the various modules 104-130 to be updated individually without affecting the overall performance of a pipe.

The product comprehension module 104 may function to obtain (e.g., retrieve) information related to various products and devices (e.g., life sciences). For example, the product comprehension module 104 may obtain product specifications (e.g., technical specifications, user manuals) for a variety of different and/or related products (e.g., different versions of the same product, different products in the same category of products). The product comprehension module 104 may obtain the information from enterprise datastores and/or external datastores.

In some embodiments, the product comprehension module 104 may function to understand the obtained information (e.g., using a large language model, multimodal model, or the like) to identify products that are similar to one or more other products (e.g., based on a similarity threshold). For example, similarities may be determined based on a comparison or analysis of some specifications of one product with other specifications of other products (e.g., different products, different versions of the product, etc.). If a user and/or model (e.g., machine learning model, large language model, multimodal model) determines that one or more other products are sufficiently similar, the product comprehension module 104 may identify (e.g., select, mark) those products as similar.

In some embodiments, the product comprehension module 104 may determine and/or assign one or more categories for products. Categories may also include sub-categories. For example, a category may be laser-based products, and a sub-category may be products that include lasers to treat particular issues (e.g., vision issues). The categories and sub-categories may be determined based on product specifications. For example, a user may analyze the product specifications and/or a machine learning model (e.g., multimodal model, large language model, etc.) may perform the analysis.

In some embodiments, the product comprehension module 104 may compare and/or record the similarities and differences between various product documents that are identified as similar. This operation may involve choosing all or specific subset of product documents from the various products that are deemed similar and are being compared. For example, a user may compare the product specifications and/or a machine learning model (e.g., multimodal model, large language model, etc.) may perform the analysis.

The hazard comprehension module 106 may function to obtain information of a specific type of document (e.g., a hazard report) of one or more products. In some embodiments, at least a portion of the specific document may be obtained from a vector store which stores data using searchable embedding values. The hazard comprehension module 106 may also clean data, preprocess data, and/or otherwise function to understand the specific type of the document (e.g., hazards) of various products.

The template comprehension module 108 may function to generate and/or obtain templates of specific document type (e.g., Risk Analysis Report). For example, the template comprehension module 108 may generate or obtain templates of a document type based on a category of a product. The templates may include data and fields that are that are common to particular categories and/or sub-categories of products.

The hazard generation module 110 may function to generate prompts (e.g., prompt for a multimodal model, large language model, etc.) based on product specifications, document specific information, and/or document specific templates. In some embodiments, the hazard generation module 110 provides the generated prompt to a multimodal model. The hazard generation module 110 may generate an output (e.g., a hazard report with attributions/rationales of how the output was generated) of the multimodal model based on the prompt. In some embodiments, the hazard generation module 110 may revise (e.g., in real-time based on user feedback) model outputs (e.g., formatted and/or modified outputs, as discussed elsewhere herein).

In some embodiments, the hazard generation module 110 may generate prompts by identifying relevant portions of documents (e.g., specifications, hazard reports) and copying only the relevant portions into the prompt. For example, the model may use a relevancy threshold to determine which portions to include in the prompt, which may significantly reduce model hallucination. The hazard generation module 110 may also confirm that generated outputs are accurate by further reviewing stored assessment documentation and comparing with the generated output. If the output is inconsistent with the stored information, the hazard generation module 110 may indicate potential errors and/or trigger generation of an updated document (e.g., hazard report) with an updated prompt.

In some embodiments, the hazard generation module 110 may generate prompts to create document with combination of one or more methodologies. One of those methodologies may involve using the recorded similarities between various products. In this case, the prompts may retrieve parts of the old document and copy them over to the new document. In another of those methodologies, prompts may use the recorded differences between various products. In this case, the prompts may generate the new document using one or more multimodal models to generate new text, tables, and pictures and paste them in to the new document. In some embodiments, the hazard generation module 110 may use prompts to combine one of more the above approaches and generate the final document.

The format compliance module 112 may function to format the output of the multimodal model based one or more formatting rules. These formatting rules may either be explicitly stated and/or the format compliance module 112 may generate prompts to understand the expected format of output document.

The content compliance module 114 may function to modify at least a portion of content of the formatted output based on one or more content compliance rules. These content compliance rules may either be explicitly stated and/or the content compliance module 114 may generate prompts to understand the expected compliance of output document. In some embodiments, the content compliance module 114 may use identified compliance documents to verify and/or change the words, graphics, audio, video content in the document. For this purpose, the content compliance module 114 may use multimodal models.

The artificial intelligence traceability module 116 may function to provide traceability and/or explainability of outputs generated by the models described herein. For example, the artificial intelligence traceability module 116 may indicate portions of data used to generate outputs and their respective data sources. The artificial intelligence traceability module 116 may also function to corroborate model outputs. For example, the artificial intelligence traceability module 116 may provide sources citations automatically and/or on-demand to corroborate or validate large language model outputs. The artificial intelligence traceability module 116 may also determine the compatibility of the different sources (e.g., data records, passages) that were used to generate a model output. For example, the artificial intelligence traceability module 116 may identify data that contradicts each other and provide a notification that the output was generated based on contradictory or conflicting information.

The artificial intelligence traceability module 116 may generate and/or otherwise provide evidence packages. For example, the artificial intelligence models described herein may place different emphases on different features. Those emphases may be quantified and/or visualized so a user (e.g., operator) can understand and validate that the artificial intelligence models are indeed paying attention to the right features and not suffering spurious corrections (e.g., global feature contributions). The artificial intelligence models described herein may also make predictions/inferences that may be associated with the extent to which each feature contributed to the predictions taking a certain value (local feature contributions).

The artificial intelligence traceability module 116 can generate and provide evidence packages of predictions and other features of the systems. For example, the drivers of artificial intelligence models of the systems can be visualized at the level of individual machine learning models and the level of individual predictions made by those models.

The model training module 118 can function to capture feedback regarding model performance (e.g., response time), model accuracy, system utilization (e.g., model processing system utilization, model processing unit utilization), and other attributes. For example, the model training module 118 may track user interactions within systems, capturing explicit feedback (e.g., through a training user interface), implicit feedback, and the like. The feedback may be used to refine models (e.g., by the model training module 118).

The model training module 118 can be used to enable tuning and learning by the model training module 118. For example, the model training module 118 may tune models based on tracking user interactions within the system, capture explicit feedback (e.g., through a training user interface), implicit feedback, etc. In some example implementations, the model training module 118 may optionally be used to accelerate knowledge base bootstrapping. Reinforcement learning may be used for explicit bootstrapping of the system with instrumentation of time spent, results clicked on, etc. Example aspects include an innovative learning framework that may bootstrap models for different enterprise environments. Example aspects include an innovative learning framework that may bootstrap models for different enterprise environments.

The model training module 118 can function to train, retrain, tune, and/or refine the models described herein. For example, models can be trained and/or fine-tuned via transfer learning techniques on feedback, product specifications, domain-specific documents and literature on the medical industry and other industries (e.g., product specifications, user manuals, equipment manuals, journals, research papers, etc.,) to provide more accurate document report generation.

The model deployment module 120 may function to obtain, generate, and/or modify some or all of the different types of models described herein (e.g., machine learning models, large language models, data models). In some implementations, the model deployment module 120 may use a variety of machine learning techniques or algorithms to generate models. As used herein, artificial intelligence and/or machine learning may include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, model deployment module 120 may generate and/or use model templates to rapidly and efficiently deploy any of the models discussed herein. For example, model templates may allow an application to be quickly configured by non-expert users using out-of-the-box templates that define everything needed for a machine-learning model to run. Each template may be applied to a plurality of assets allowing easy (e.g., efficient in terms of time and/or computational resources) scaling of model deployments to hundreds (or more) of assets across dozens (or more) facilities.

In some embodiments, a large language model is a deep learning model (e.g., generated by a deep learning algorithm) that may recognize, summarize, translate, predict, and/or generate text and other content based on knowledge gained from massive datasets. Large language models may comprise transformer-based models. Large language models can include Google's Gemini, OpenAI's GPT, Anthropic Claude, Microsoft's Transformer, among others. Large language models can process vast amounts of data, leading to improved accuracy in prediction and classification tasks. The large language models can use this information to learn patterns and relationships, which can help them make improved predictions and groupings relative to other machine learning models. Large language models can include artificial neural network transformers that are pre-trained using supervised and/or semi-supervised learning techniques. In some embodiments, large language models comprise deep learning models specialized in text generation. Large language models, in some embodiments, may be characterized by a significant number of parameters (e.g., in the tens or hundreds of billions of parameters) and the large corpuses of text used to train them.

The model deployment module 120 can generate, deploy, and/or use model templates to generate or deploy models, which can accelerate deployment of models across subjects and use cases. In various implementations, as used herein, models may include machine learning models, statistical models, large language models, and or other models. More specifically, the model deployment module 120 can generate and store many different model templates that each describe respective features, targets, modeling approaches, training set definitions, training cadences, and/or inference cadences for a model. For example, training set definitions can include the start date of any timeseries data used for training and end date of any timeseries data used for training. Training and inference cadence define how frequently the machine learning model is used to be retrained and generate predictions, respectively. Examples are hourly, daily, weekly, monthly, quarterly, annually, etc. Additionally, training and inference can be triggered by a user (e.g., through an interface) or by some sort of event (e.g., retrain if the model accuracy drops below a specified threshold).

The model input module 124 can function to obtain, generate, and provide model inputs (e.g., to any of the models described herein.). The model input module 124 may also use different model configurations and/or feature configuration for model inputs. More specifically, features can be pre-specified transformations of data that are relevant to modeling resources using data described herein. In some embodiments, features can be defined by end users through systems (e.g., through a graphical user interface generated by interface module 128). More specifically, the approach can be simplified by identifying the underlying data used in the feature transformations through identifiers or descriptions of that data.

Feature assignment to models can also be manual and/or automatic. For example, the features can be assigned to models by an end user or system (manual), and/or the features can be assigned to models using templates (automatic), described elsewhere herein. Furthermore, once features are assigned to a model, they can be used in training (e.g., by the machine learning-based resource prediction and optimization system) based on the availability of underlying data (e.g., feature(s) can be excluded if the underlying data is insufficient or absent), and/or an importance (e.g., relative value) to the models through different techniques (e.g., forward feature selection, leave-one-out, etc.), and features can be included based on an extent to which they contribute to model accuracy.

The enterprise deployment module 122 can function to deploy systems (e.g., enterprise generative artificial intelligence assessment framework generation 100 and/or instances thereof) within one or more enterprise environments. For example, the enterprise deployment module 122 may deploy the enterprise generative artificial intelligence assessment framework generation 100 entirely within a single enterprise environment. This may allow, for example, sensitive data to be utilized by the enterprise generative artificial intelligence assessment framework generation 100 without exposing it outside the enterprise environment. In some embodiments, a model-drive architecture and/or type system of an AI platform (e.g., AI platform 402) allows for rapid deployment of the enterprise generative artificial intelligence assessment framework generation 100 within an enterprise environment (e.g., enterprise environment 403).

The anti-hallucination and attribution module 126 may function to prevent and/or mitigate hallucination and provide attribution (e.g., rationales) for outputs generated by the models described herein. For example, anti-hallucination and attribution module 126 may limit data used by the models to particular sources (e.g., enterprise systems and enterprise datastores within a secure enterprise environment). The anti-hallucination and attribution module 126 may also provide source citations for the generated outputs. For example, each column, row, value, and/or other features of a document (e.g., hazard report) may include attribution. In some embodiments, the document generated by the hazard generation module 110 can include column, row, or other features, that include the attributions. The anti-hallucination and attribution module 126 may cooperate with the artificial intelligence traceability module 116 to provide such functionality.

The interface module 128 can function to present, via a graphical user interface (GUI), model outputs (e.g., initial outputs, formatted and/or modified outputs, etc.). In some embodiments, the interface module 128 can receive (e.g., from a user and/or system) feedback through the GUI associated with the formatted and modified output The alerting module 130 can function to generate, provide (e.g., transmit), and/or receive alerts. For example, an alert can be generated when new or updated information (e.g., new or updated specifications, hazard reports, etc.) is available.

The communication module 132 can function to send requests, transmit and receive communications, and/or otherwise provide communication with one or more of the systems, services, modules, registries, repositories, engines, layers, devices, datastores, and/or other components described herein. In a specific implementation, the communication module 132 may function to encrypt and decrypt communications. The communication module 132 may function to send requests to and receive data from one or more systems through a network or a portion of a network. In a specific implementation, the communication module 132 may send requests and receive data through a connection, all or a portion of which can be a wireless connection. The communication module 132 may request and receive messages, and/or other communications from associated systems, modules, layers, and/or the like. Communications may be stored in the enterprise generative artificial intelligence assessment framework generation datastore 140.

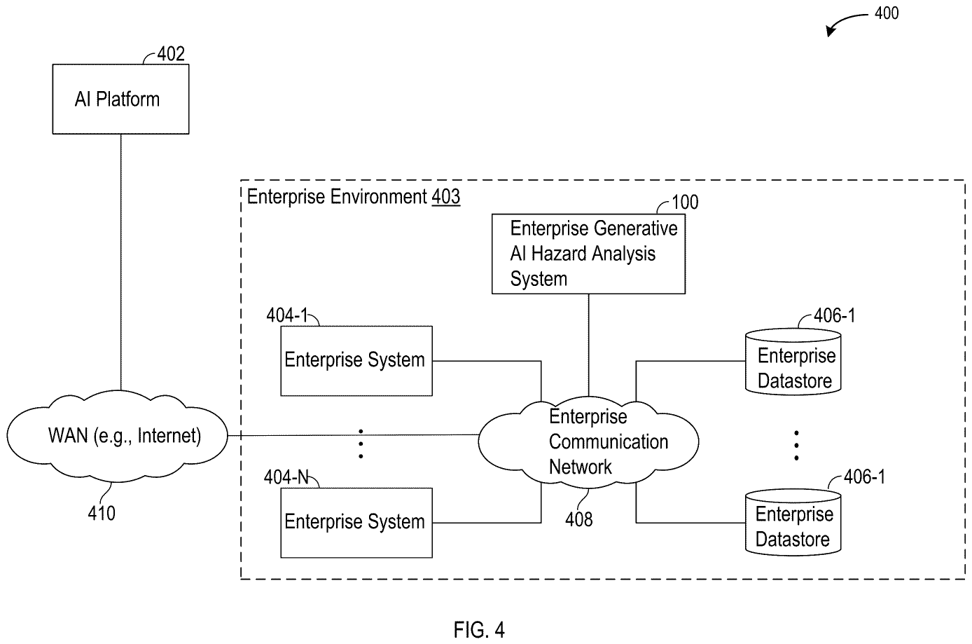

In some embodiments, an instance of an enterprise generative artificial intelligence assessment framework generation 100 can be deployed to and executed within one or more enterprise environments (e.g., a single enterprise environment of a life sciences company), as discussed further with reference to FIG. 4.

In various embodiments, some or all of the modules described herein may use various machine learning models (e.g., multimodal models, large language models) to perform the functionality described herein.

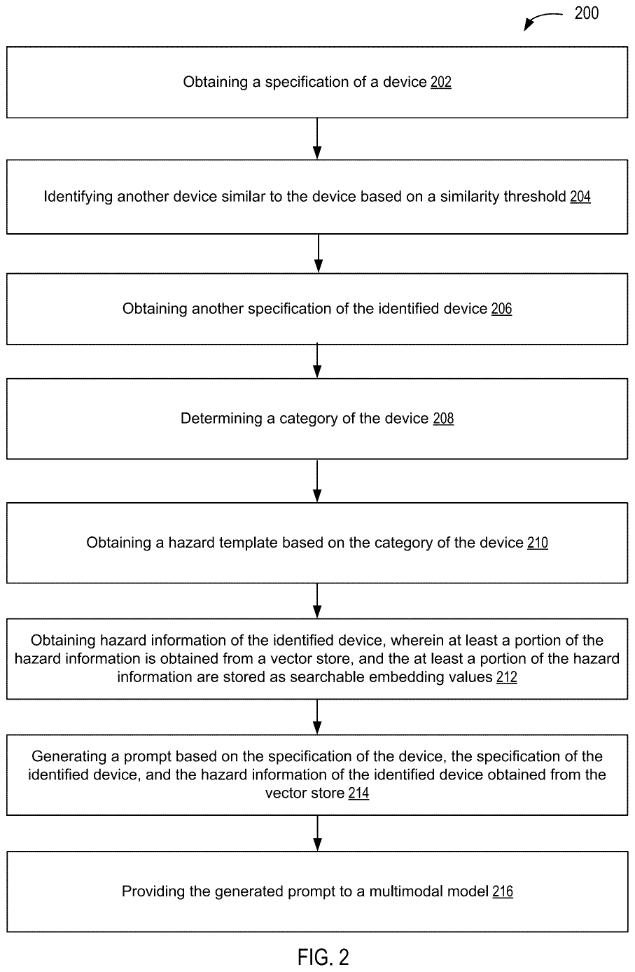

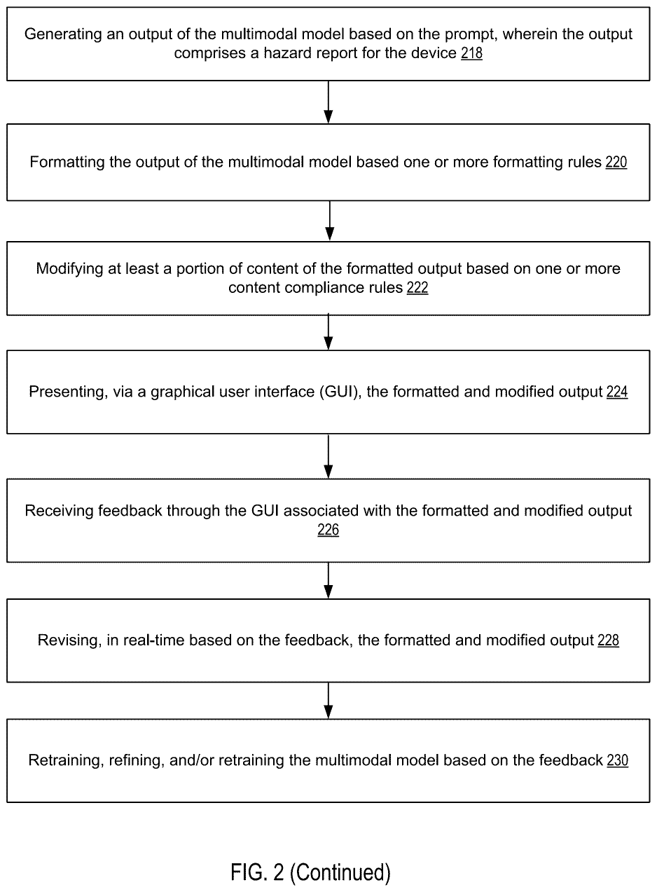

FIG. 2 depicts a flowchart 200 of an example of a method of enterprise generative artificial intelligence assessment framework generation according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 202, a computing system (e.g., enterprise generative artificial intelligence assessment framework generation 100) obtains a specification (e.g., technical specification, user manual) of a product (e.g., medical device). For example, the product may be a new product, a product currently in development, a product that is being updated, etc. In some embodiments, a product comprehension module (e.g., product comprehension module 104) obtains the specification.

In step 204, the computing system identifies another product that is similar to the product based on a similarity threshold. For example, similarities may be determined based on a comparison or analysis of the specification with other specifications of other products (e.g., different products, different versions of the product, etc.). If a user and/or model (e.g., machine learning model, large language model, multimodal model) determines that one or more other products sufficiently similar to the product, then the computing system identifies those one or more products. In some embodiments, the product comprehension module identifies the similarities and the similar product(s).

In step 206, the computing system obtains another specification of the identified product. In some embodiments, the product comprehension module obtains the other specification.

In step 208, the computing system determines a category of the product. Categories may also include sub-categories. A category may be laser-based products, products to treat particular issues (e.g., cardia issues, vision issues, etc.). The category may be determined based on the specification (e.g., analysis of one or more specifications by a multimodal model, large language model, etc.). In some embodiments, the product comprehension module determines the category.

In step 210, the computing system obtains a hazard template based on the category of the product. In some embodiments, a template comprehension module (e.g., template comprehension module 108) obtains the hazard template.

In step 212, the computing system obtains hazard information (e.g., a hazard report) of the identified product, wherein at least a portion of the hazard information is obtained from a vector store, and the at least a portion of the hazard information is stored as searchable embedding values. In some embodiments, a hazard comprehension module (e.g., hazard comprehension module 106) obtains the hazard information.

In step 214, the computing system generates a prompt (e.g., a prompt for a multimodal model, large language model, etc.) based on the specification of the product, the specification of the identified product, the hazard information of the identified product obtained from the vector store, and/or the hazard template. In some embodiments, a hazard generation module (e.g., hazard generation module 110) generates the prompt.

In step 216, the computing system provides the generated prompt to a multimodal model. In some embodiments, the hazard generation module provides the prompt to the multimodal model.

In step 218, the computing system generates an output of the multimodal model based on the prompt. The output may be and/or comprise one or more hazard reports for the product. In some embodiments, the hazard generation module generates the output.

In step 220, the computing system formats the output of the multimodal model based one or more formatting rules. In some embodiments, a format compliance module (e.g., format compliance module 112) formats the output.

In step 222, the computing system modifies at least a portion of content of the formatted output based on one or more content compliance rules. In some embodiments, a content compliance module (e.g., content compliance module 114) modifies the content.

In step 224, the computing system presents, via a graphical user interface (GUI), the formatted and modified output. In some embodiments, an interface module (e.g., interface module 128) presents the formatted and modified output.

In step 226, the computing system receives (e.g., from a user and/or system) feedback through the GUI associated with the formatted and modified output. In some embodiments, the hazard generation module and/or model training module (e.g., model training module 118) receives the feedback.

In step 228, the computing system revises, in real-time based on the feedback, the formatted and modified output. In some embodiments, the hazard generation module revises the formatted and modified output.

In step 230, the computing system retrains, refines, and/or tunes the multimodal model based on the feedback. In some embodiments, the model training module retrains, refines, and/or tunes the multimodal model.

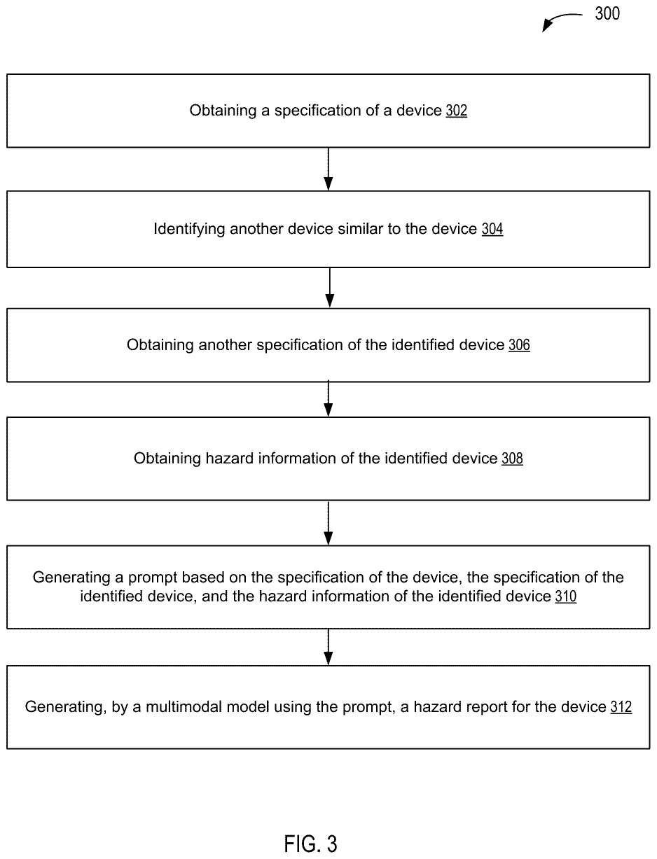

FIG. 3 depicts a flowchart 300 of an example of a method of enterprise generative artificial intelligence assessment framework generation according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 302, a computing system (e.g., enterprise generative artificial intelligence assessment framework generation 100) obtains a specification of a product. In some embodiments, a product comprehension module (e.g., product comprehension module 104) obtains the specification of the product.

In step 304, the computing system identifies another product similar to the product. In some embodiments, the product comprehension module identifies other product (or other products).

In step 306, the computing system obtains another specification of the identified product. In some embodiments, the product comprehension module 104 obtains the specification of the identified product(s).

In step 308, the computing system obtains hazard information of the identified product. In some embodiments, a hazard comprehension module (e.g., hazard comprehension module 106) obtains the hazard information.

In step 310, the computing system generates a prompt based on the specification of the product, the specification of the identified product, and the hazard information of the identified product. In some embodiments, a hazard generation module (e.g., hazard generation module 110) generates the prompt.

In step 312, the computing system generates, by a multimodal model using the prompt, a hazard report for the product. In some embodiments, hazard generation module 110 generates the hazard report for the product.

FIG. 4 depicts a diagram 400 of an example network system for enterprise generative artificial intelligence assessment framework generation according to some embodiments. In the example of FIG. 4, the network system includes an enterprise generative artificial intelligence assessment framework generation 100, an artificial intelligence platform system 402, enterprise environment 403, enterprise systems 404, enterprise datastore 406, and an enterprise communication network 408, and wide area communication network 410 (e.g., the Internet).

In the example of FIG. 4, the AI platform 402 may have a model-driven architecture implementing a type system for rapid development and deployment. In one example, the AI platform 402 may include some or all of the functionality of the enterprise generative artificial intelligence assessment framework generation 100, and it may deploy the enterprise generative artificial intelligence assessment framework generation 100, or an instance of an enterprise generative artificial intelligence assessment framework generation 100, entirely within the enterprise environment 403. This may, for example, ensure the security of sensitive data (e.g., medical data) and prevent model hallucination by being able to securely utilize the sensitive data without exposing that data outside of the enterprise environment.

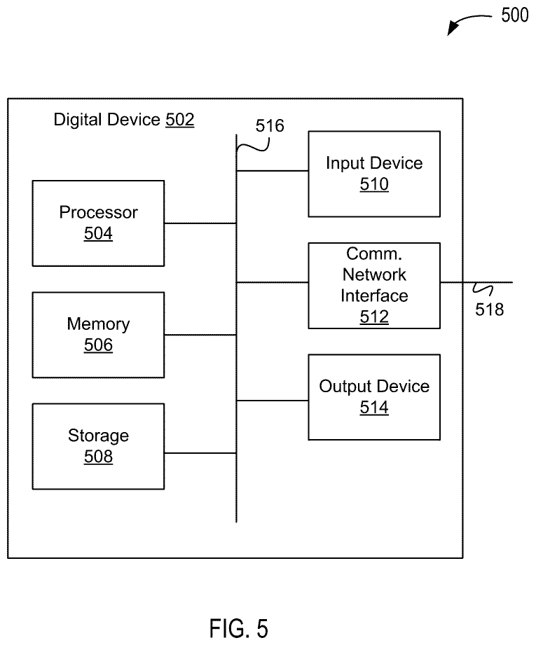

FIG. 5 depicts a diagram 500 of an example of a computing device 502. Any of the systems, engines, datastores, and/or networks described herein may comprise an instance of one or more computing devices 502. In some embodiments, functionality of the computing device 502 is improved to the perform some or all of the functionality described herein. The computing device 502 comprises a processor 504, memory 506, storage 508, an input device 510, a communication network interface 512, and an output device 514 communicatively coupled to a communication channel 516. The processor 504 is configured to execute executable instructions (e.g., programs). In some embodiments, the processor 504 comprises circuitry or any processor capable of processing the executable instructions.

The memory 506 stores data. Some examples of memory 506 include storage devices, such as RAM, ROM, RAM cache, virtual memory, etc. In various embodiments, working data is stored within the memory 506. The data within the memory 506 may be cleared or ultimately transferred to the storage 508.

The storage 508 includes any storage configured to retrieve and store data. Some examples of the storage 508 include flash drives, hard drives, optical drives, cloud storage, and/or magnetic tape. Each of the memory system 506 and the storage system 508 comprises a computer-readable medium, which stores instructions or programs executable by processor 504.

The input device 510 is any device that inputs data (e.g., mouse and keyboard). The output device 514 outputs data (e.g., a speaker or display). It will be appreciated that the storage 508, input device 510, and output device 514 may be optional. For example, the routers/switchers may comprise the processor 504 and memory 506 as well as a device to receive and output data (e.g., the communication network interface 512 and/or the output device 514).

The communication network interface 512 may be coupled to one or more networks (e.g., enterprise communication network 408 and/or network 410) via the link 518. The communication network interface 512 may support communication over an Ethernet connection, a serial connection, a parallel connection, and/or an ATA connection. The communication network interface 512 may also support wireless communication (e.g., 802.11 a/b/g/n, WiMax, LTE, WiFi). It will be apparent that the communication network interface 512 may support many wired and wireless standards.

It will be appreciated that the hardware elements of the computing device 502 are not limited to those depicted in FIG. 5. A computing device 502 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 504 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Examples include, but are not limited to:
1. A method comprising:
identifying background information for a target product;
identifying one or more potential comparison products based on the background information using a vector store which stores data using searchable embedding values, wherein a specification is associated with each of the one or more potential comparison products;
generating an assessment of the target product using a multimodal model, wherein the multimodal model determines similarities between the target product and one or more potential comparison products and passages from the specifications associated with each of the one or more potential comparison products based on the similarities.
2. A method comprising:
obtaining a specification of a device or product;
identifying another device or product similar to the device or product based on a similarity threshold;
obtaining another specification of the identified device or product;
determining a category of the device or product;
obtaining a document template based on the category of the device or product;
obtaining document information of the identified device or product, wherein at least a portion of the document information is obtained from a vector store, and the at least a portion of the document information are stored as searchable embedding values;
generating a prompt based on the specification of the device or product, the specification of the identified device or product, and the document information of the identified device or product obtained from the vector store;
providing the generated prompt to a multimodal model;
generating an output of the multimodal model based on the prompt, wherein the output comprises a document for the device or product;
formatting the output of the multimodal model based one or more formatting rules;
modifying at least a portion of content of the formatted output based on one or more content compliance rules;
presenting, via a graphical user interface (GUI), the formatted and modified output;
receiving feedback through the GUI associated with the formatted and modified output;
revising, in real-time based on the feedback, the formatted and modified output; and
retraining, refining, and/or tuning the multimodal model based on the feedback.
3. The method of example 2, wherein the device or product is a new or updated product relative to the identified product.
4. The method of example 2, wherein the multimodal model comprises a large language model.
5. The method of example 2, wherein the output comprises a document including attribution for different portion of the output.
6. A system comprising:
one or more processors; and
memory storing instructions that, when executed by the one or more processors, cause the system to perform:
   obtaining a specification of a product;
   identifying another product similar to the product based on a similarity threshold;
   obtaining another specification of the identified product;
   determining a category of the product;
   obtaining a document template based on the category of the product;
   obtaining document information of the identified product, wherein at least a portion of the document information is obtained from a vector store, and the at least a portion of the document information are stored as searchable embedding values;
   generating a prompt based on the specification of the product, the specification of the identified product, and the document information of the identified product obtained from the vector store;
   providing the generated prompt to a multimodal model;
   generating an output of the multimodal model based on the prompt;
   formatting the output of the multimodal model based one or more formatting rules;
   modifying at least a portion of content of the formatted output based on one or more content compliance rules;
   presenting, via a graphical user interface (GUI), the formatted and modified output;
   receiving feedback through the GUI associated with the formatted and modified output;
   revising, in real-time based on the feedback, the formatted and modified output; and
   retraining, refining, and/or tunes the multimodal model based on the feedback.
7. The system of example 6, wherein the system is deployed entirely within an enterprise environment.
8. A system comprising:
one or more processors; and
memory storing instructions that, when executed by the one or more processors, cause the system to perform:
   obtaining a specification of a product;
   identifying another product similar to the product;
   obtaining another specification of the identified product;
   obtaining document information of the identified product;
   generating a prompt based on the specification of the product, the specification of the identified product, and the document information of the identified product; and
   generating, by a multimodal model using the prompt, a document for the product.
9. The system of example 8, wherein the system is deployed entirely within an enterprise environment.
10. A method comprising:
obtaining a specification of a product;
obtaining other specifications of other products;
identifying another product similar to the product based on the other specifications of the other products;
obtaining document information of the identified product;
generating a prompt based on the specification of the product, the specification of the identified product, and the document information of the identified product; and
generating, by a multimodal model using the prompt, a document for the product.
11. A system comprising:
one or more processors; and
memory storing instructions that, when executed by the one or more processors, cause the system to perform:
   obtaining a specification of a product;
   obtaining other specifications of other products;
   identifying another product similar to the product based on the other specifications of the other products;
   obtaining document information of the identified product;
   generating a prompt based on the specification of the product, the specification of the identified product, and the document information of the identified product; and
   generating, by a multimodal model using the prompt, a document for the product.
12. The system of example 11, wherein the system is deployed entirely within an enterprise environment.
13. An enterprise generative artificial intelligence hazard analysis system, comprising:
a server computer including:
   a management module configured to oversee the operations of the system;
   a product comprehension module configured to understand and analyze product-related data;
   a hazard comprehension module configured to identify and assess potential hazards associated with the product;
   a template comprehension module configured to interpret and utilize predefined templates for hazard analysis;
   a hazard generation module configured to generate hazard scenarios based on the analyzed data;
   a format compliance module configured to ensure that the generated hazard scenarios comply with required formats;
   a content compliance module configured to verify that the content of the hazard scenarios meets regulatory and organizational standards;
   an artificial intelligence traceability module configured to track and document the decision-making processes of the AI models used in the system;
   a model training module configured to train AI models using relevant data;
   a model deployment module configured to deploy trained AI models for use in hazard analysis;
   an enterprise deployment module configured to integrate the system with enterprise-level applications and infrastructure;
   a model input module configured to receive input data for the AI models;
   an anti-hallucination and attribution module configured to prevent and attribute hallucinations in the AI-generated outputs;
   an interface module configured to provide user interfaces for interacting with the system;
   an alerting module configured to generate alerts based on the hazard analysis results;
   a communication module configured to facilitate communication between different components of the system; and
   an enterprise generative artificial intelligence hazard analysis system datastore configured to store data related to the hazard analysis.
14. The system of example 13, wherein the management module is configured to manage data associated with the enterprise generative artificial intelligence assessment framework generation, including creating, reading, updating, deleting, or otherwise accessing data.
15. The system of example 14, wherein the management module manages one or more datastores, including local and remote datastores, associated with the enterprise generative artificial intelligence assessment framework generation.
16. The system of example 15, wherein the management module performs operations manually through a user interacting with a graphical user interface generated by the interface module, and/or automatically triggered by one or more other modules.
17. The system of example 13, wherein the management module is configured to manage, integrate, and normalize disparate data from disparate data sources, including enterprise data sources and external third-party data sources.
18. The system of example 17, wherein the management module integrates various types of data, including product information, quality and regulatory information, historical data, and real-time or live data, using predefined integration rules.
19. The system of example 13, wherein the management module is configured to create and manage execution pipes for some or all of the modules, allowing the modules to be executed serially and/or in parallel to increase processing speed, reduce performance delays, and enable modular updates.
20. The system of example 13, wherein the product comprehension module is configured to obtain information related to various products and devices, including product specifications and user manuals, from enterprise datastores and/or external datastores.
21. The system of example 20, wherein the product comprehension module uses a large language model or multimodal model to understand the obtained information and identify products that are similar to one or more other products based on a similarity threshold.
22. The system of example 21, wherein the product comprehension module determines and assigns categories and sub-categories for products based on product specifications.
23. The system of example 22, wherein the product comprehension module compares and records the similarities and differences between various product documents identified as similar, using a machine learning model to perform the analysis.
24. The system of example 13, wherein the hazard comprehension module is configured to obtain and understand hazard reports of various products, including cleaning and preprocessing data from vector stores that store data using searchable embedding values.
25. The system of example 13, wherein the template comprehension module is configured to generate and obtain templates of specific document types based on product categories, including data and fields common to particular categories and sub-categories of products.
26. The system of example 13, wherein the hazard generation module is configured to generate prompts for a multimodal model based on product specifications, document-specific information, and document-specific templates, and to generate outputs such as hazard reports with attributions and rationales.
27. The system of example 26, wherein the hazard generation module is further configured to revise model outputs in real-time based on user feedback, ensuring accuracy by reviewing stored assessment documentation and comparing it with the generated output.
28. The system of example 13, wherein the format compliance module is configured to format the output of the multimodal model based on one or more formatting rules, either explicitly stated or generated through prompts.
29. The system of example 13, wherein the content compliance module is configured to modify at least a portion of the formatted output based on one or more content compliance rules, using identified compliance documents and multimodal models to verify and change the content.
30. The system of example 13, wherein the artificial intelligence traceability module is configured to provide traceability and explainability of outputs generated by the models, including indicating portions of data used, their respective data sources, and corroborating model outputs with source citations.
31. The system of example 30, wherein the artificial intelligence traceability module is further configured to generate evidence packages that quantify and visualize the emphasis placed on different features by the artificial intelligence models, providing insights into global and local feature contributions.
32. The system of example 13, wherein the model training module is configured to capture feedback regarding model performance, accuracy, and system utilization, using the feedback to refine and tune the models through techniques such as transfer learning and reinforcement learning.
33. The system of example 32, wherein the model training module is further configured to train, retrain, and fine-tune models using domain-specific documents and literature, including product specifications, user manuals, and research papers, to improve document report generation accuracy.
34. The system of example 13, wherein the model deployment module is configured to obtain, generate, and modify various types of models, including machine learning models, large language models, and data models, using a variety of machine learning techniques and algorithms.
35. A system for enterprise generative artificial intelligence hazard analysis, the system comprising:
control circuitry configured to:
   identify background information for a target product;
   identify one or more potential comparison products based on the background information using a vector store which stores data using searchable embedding values, wherein a specification is associated with each of the one or more potential comparison products;
   generate an assessment of the target product using a multimodal model, wherein the multimodal model determines similarities between the target product and one or more potential comparison products and passages from the specifications associated with each of the one or more potential comparison products based on the similarities.

The present invention(s) are described above with reference to example embodiments. It will be apparent to those skilled in the art that various modifications may be made, and other embodiments may be used without departing from the broader scope of the present invention(s). Therefore, these and other variations upon the example embodiments are intended to be covered by the present invention(s).

What is claimed is:

1. A method comprising:
obtaining a specification of a device or product;
identifying another device or product similar to the device or product based on a similarity threshold;
obtaining another specification of the identified device or product;
determining a category of the device or product;
obtaining a document template based on the category of the device or product;
obtaining document information of the identified device or product, wherein at least a portion of the document information is obtained from a vector store, and the at least a portion of the document information are stored as searchable embedding values;
generating a prompt based on the specification of the device or product, the specification of the identified device or product, and the document information of the identified device or product obtained from the vector store;
providing the generated prompt to a multimodal model;
generating an output of the multimodal model based on the prompt, wherein the output comprises a document for the device or product;
formatting the output of the multimodal model based one or more formatting rules;
modifying at least a portion of content of the formatted output based on one or more content compliance rules;
presenting, via a graphical user interface (GUI), the formatted and modified output;
receiving feedback through the GUI associated with the formatted and modified output;
revising, in real-time based on the feedback, the formatted and modified output; and
retraining, refining, and/or tuning the multimodal model based on the feedback.

2. The method of claim 1, wherein the device or product is a new or updated product relative to the identified product.

3. The method of claim 1, wherein the multimodal model comprises a large language model.

4. The method of claim 1, wherein the output comprises a document including attribution for different portion of the output.

5. A system comprising:
one or more processors; and
memory storing instructions that, when executed by the one or more processors, cause the system to perform:
obtaining a specification of a product;
identifying another product similar to the product based on a similarity threshold;
obtaining another specification of the identified product;
determining a category of the product;
obtaining a document template based on the category of the product;
obtaining document information of the identified product, wherein at least a portion of the document information is obtained from a vector store, and the at least a portion of the document information are stored as searchable embedding values;
generating a prompt based on the specification of the product, the specification of the identified product, and the document information of the identified product obtained from the vector store;
providing the generated prompt to a multimodal model;
generating an output of the multimodal model based on the prompt;
formatting the output of the multimodal model based one or more formatting rules;
modifying at least a portion of content of the formatted output based on one or more content compliance rules;
presenting, via a graphical user interface (GUI), the formatted and modified output;
receiving feedback through the GUI associated with the formatted and modified output;
revising, in real-time based on the feedback, the formatted and modified output; and
retraining, refining, and/or tunes the multimodal model based on the feedback.

6. The system of claim 5, wherein the system is deployed entirely within an enterprise environment.

7. An enterprise generative artificial intelligence hazard analysis system, comprising:
a server computer including:
a management module configured to oversee the operations of the system;
a product comprehension module configured to understand and analyze product-related data;
a hazard comprehension module configured to identify and assess potential hazards associated with the product;
a template comprehension module configured to interpret and utilize predefined templates for hazard analysis;
a hazard generation module configured to generate hazard scenarios based on the analyzed data;
a format compliance module configured to ensure that the generated hazard scenarios comply with required formats;
a content compliance module configured to verify that the content of the hazard scenarios meets regulatory and organizational standards;
an artificial intelligence traceability module configured to track and document the decision-making processes of the AI models used in the system;
a model training module configured to train AI models using relevant data;
a model deployment module configured to deploy trained AI models for use in hazard analysis;
an enterprise deployment module configured to integrate the system with enterprise-level applications and infrastructure;
a model input module configured to receive input data for the AI models;
an anti-hallucination and attribution module configured to prevent and attribute hallucinations in the AI-generated outputs;
an interface module configured to provide user interfaces for interacting with the system;
an alerting module configured to generate alerts based on the hazard analysis results;
a communication module configured to facilitate communication between different components of the system; and
an enterprise generative artificial intelligence hazard analysis system datastore configured to store data related to the hazard analysis.

8. The system of claim 7, wherein the management module is configured to manage data associated with the enterprise generative artificial intelligence assessment framework generation, including creating, reading, updating, deleting, or otherwise accessing data.

9. The system of claim 8, wherein the management module manages one or more datastores, including local and remote datastores, associated with the enterprise generative artificial intelligence assessment framework generation.

10. The system of claim 9, wherein the management module performs operations manually through a user interacting with a graphical user interface generated by the interface module, and/or automatically triggered by one or more other modules.

11. The system of claim 7, wherein the management module is configured to manage, integrate, and normalize disparate data from disparate data sources, including enterprise data sources and external third-party data sources.

12. The system of claim 11, wherein the management module integrates various types of data, including product information, quality and regulatory information, historical data, and real-time or live data, using predefined integration rules.

13. The system of claim 7, wherein the management module is configured to create and manage execution pipes for some or all of the modules, allowing the modules to be executed serially and/or in parallel to increase processing speed, reduce performance delays, and enable modular updates.

14. The system of claim 7, wherein the product comprehension module is configured to obtain information related to various products and devices, including product specifications and user manuals, from enterprise datastores and/or external datastores.

15. The system of claim 14, wherein the product comprehension module uses a large language model or multimodal model to understand the obtained information and identify products that are similar to one or more other products based on a similarity threshold.

16. The system of claim 15, wherein the product comprehension module determines and assigns categories and sub-categories for products based on product specifications.

17. The system of claim 7, wherein the hazard comprehension module is configured to obtain and understand hazard reports of various products, including cleaning and preprocessing data from vector stores that store data using searchable embedding values.

18. The system of claim 7, wherein the template comprehension module is configured to generate and obtain templates of specific document types based on product categories, including data and fields common to particular categories and sub-categories of products.

19. The system of claim 7, wherein the hazard generation module is configured to generate prompts for a multimodal model based on product specifications, document-specific information, and document-specific templates, and to generate outputs such as hazard reports with attributions and rationales.

20. The system of claim 19, wherein the hazard generation module is further configured to revise model outputs in real-time based on user feedback, ensuring accuracy by reviewing stored assessment documentation and comparing it with the generated output.
